(19) United States
(12) Patent Application Publication
(10) Pub. No.: US 2021/0206403 A1
(43) Pub. Date: Jul. 8, 2021

(54) SYSTEMS AND METHODS FOR VEHICLE ORIENTATION DETERMINATION

(71) Applicant: Westinghouse Air Brake Technologies Corporation, Wilmerding, PA (US)

(72) Inventor: Matthew Vrba, Marion, IA (US)

(21) Appl. No.: 16/733,565

(22) Filed: Jan. 3, 2020

(51) Int. Cl. B61L 3/00; G06T 7/73; B61L 25/02

(52) U.S. Cl. CPC B61L 3/008; B61L 25/026; G06T 7/73

(57) ABSTRACT

A system includes one or more processors. The one or more processors are configured to receive image information from an vision sensor disposed on a vehicle, determine timing information indicating a time at which the image information was obtained, determine an orientation of the vehicle using the timing information, and control the vehicle based on the orientation that is determined.

### BACKGROUND

### Technical Field

The subject matter described relates to systems and methods that determine vehicle orientation.

Discussion of Art.

Existing approaches for determining orientation of vehicles such as locomotives utilize magnetometers, saved or historical information of direction, or human input to determine a direction which the vehicle faces. Alternatively, the vehicle may be moved a distance to determine which direction it faces. Such approaches, however, require costly equipment (e.g., magnetometers), rely on human input, and/or or require movement of the vehicle.

### BRIEF DESCRIPTION

In one embodiment, a system includes one or more processors. The one or more processors are configured to receive image information from a vision sensor disposed on a vehicle, determine timing information indicating a time at which the image information was obtained, determine an orientation of the vehicle using the timing information, and control the vehicle based on the orientation that is determined.

In one embodiment, a vehicle includes at least one camera, a propulsion system, and a control system. The at least one camera is disposed on the vehicle. The propulsion system is disposed on the vehicle, and is configured to provide tractive efforts to move the vehicle. The control system operably coupled to the at least one camera and the propulsion system. The control system includes one or more processors configured to receive image information from the at least one camera disposed on the vehicle, the image information including an image output from the at least one camera disposed on the vehicle; determine an orientation of the vehicle using the image output from the at least one camera disposed on the vehicle; provide control signals to the propulsion system to control the vehicle based on the determined orientation.

In one embodiment, a vehicle includes at least one camera disposed on the vehicle, a propulsion system disposed on the vehicle, and a control system. The propulsion system is disposed on the vehicle, and is configured to provide tractive efforts to move the vehicle. The control system is operably coupled to the at least one camera and the propulsion system. The control system includes one or more processors configured to receive image information from the at least one camera disposed on the vehicle, determine timing information indicating a time at which the image information was obtained, determine an orientation of the vehicle using the timing information, and provide control signals to the propulsion system to control the vehicle based on the determined orientation.

### BRIEF DESCRIPTION OF THE DRAWINGS

The inventive subject matter may be understood from reading the following description of non-limiting embodiments, with reference to the attached drawings, wherein below:

FIG. 1 illustrates a schematic block diagram of an example vehicle;

FIG. 2 illustrates an example image including display of timing information;

FIG. 3 illustrates an example image including shadows of rails;

FIG. 4 illustrates an example image including landmark information; and

FIG. 5 illustrates a schematic block diagram of an example vehicle having forward and rearward facing cameras.

### DETAILED DESCRIPTION

Embodiments of the subject matter described herein relate to systems and methods that determine vehicle orientation. Various embodiments provide for reduced cost, improved accuracy, and/or improved convenience in comparison to previously known approaches. Various embodiments utilize an image from a vision sensor such as a camera having a known orientation (e.g., forward facing relative to a vehicle), and apply image processing to determine the facing direction or direction of orientation based on aspects of the image. Additionally, various examples also use information from a time stamp associated with the image. For example, location of shadows, the presence of certain objects, and/or the presence of specific landmarks may be used at known locations. By way of example, for embodiments related to rail vehicles, the location of shadows, presence of certain objects, and/or presence of specific landmarks may be used at yards and stations where a trip initialization is most likely. Various examples use cameras or vision sensors already located on vehicles and used for additional purposes during vehicle operation, reducing the cost of equipment for implementation. By using components already on vehicles but coupled in new ways (e.g., coupling a camera to a processing unit to utilize image information from the camera in a new way), various embodiments improve the functioning of processing on-board vehicles.

It may be noted that while example embodiments may be discussed in connection with rail vehicle systems, that not all embodiments described herein are limited to rail vehicle systems and/or positive control systems. For example, one or more embodiments of the systems and methods described herein can be used in connection with other types of vehicles, such as automobiles, trucks, buses, mining vehicles, marine vessels, or the like.

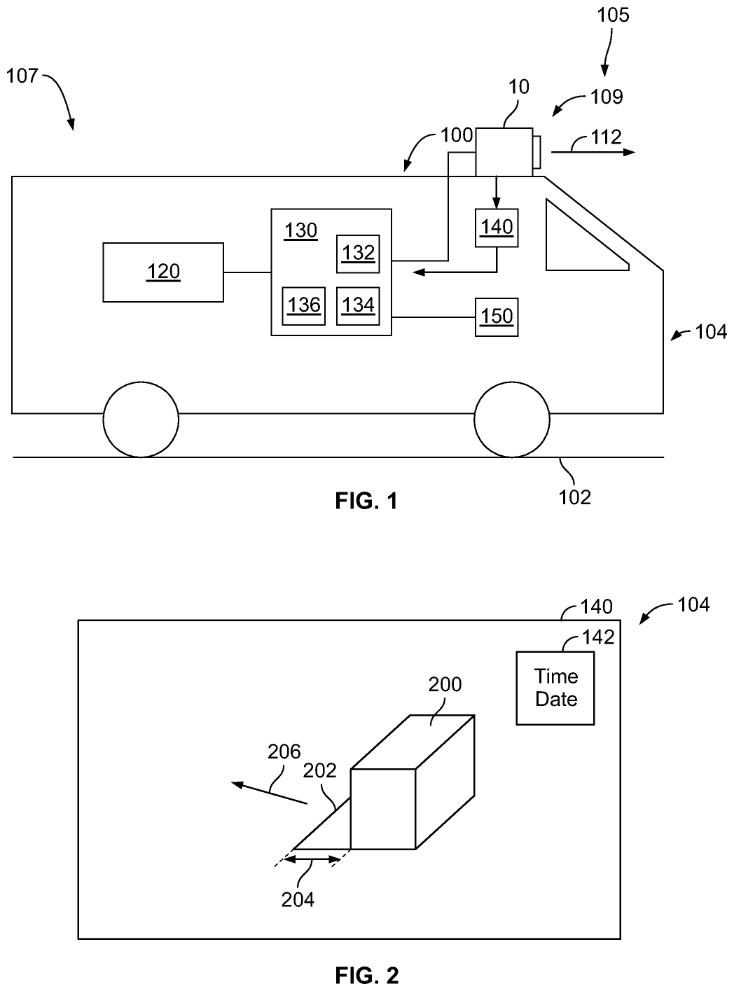

FIG. 1 illustrates an example vehicle 100 disposed along a route 102. In the depicted example, the route 102 is a track or rail, and the vehicle 100 is a rail vehicle such as a locomotive. Other types of routes and/or vehicle may be used in various embodiments. In various embodiments, the route 102 is of a network 104 including multiple routes and vehicles that is administered by a back office system of a positive train control (PTC) system, and the orientation of the vehicle 100 may be utilized by the PTC system in determining control signals to be sent to the vehicle 100.

The depicted example vehicle 100 includes a camera 110, a propulsion system 120, and a control system 130. The vehicle 100 has a front portion 105 and a rear portion 107. Generally, the camera 110 acquires imaging information that is utilized (e.g., by the control system 130) to determine an orientation of the vehicle 100. In the illustrated example, the control system 130 also provides control signals to the propulsion system 120. In other examples, the control system 130 may be disposed on-board or off-board the vehicle 100 and used for determining vehicle orientation with a separate system used to control movement of the vehicle 100.

The depicted camera 110 is disposed on the vehicle 100. In the illustrated embodiment, a single camera 110 facing in a forward direction 112 (e.g., a forward direction defined by a configuration of the vehicle 100) is employed. However, additional or alternative cameras in one or more other directions may be utilized in various embodiments. The camera 110 provides an example of a vision sensor 109, and acquires image information from an environment disposed near the vehicle 100 in the direction toward which the camera 110 is oriented. Other types of vision sensor 109 may be employed additionally or alternatively in various embodiments.

The depicted propulsion system 120 is disposed on the vehicle 100, and is configured to provide tractive efforts to the vehicle 100. For example, in some embodiments, the propulsion system 120 includes one or more engines and/or motors to propel the vehicle 100 and/or one or more of friction brakes, air brakes, or regenerative brakes to slow or stop the vehicle 100.

The control system 130 is operably coupled to the camera 110 and the propulsion system 120. For example, the control system 130 may be coupled to the camera 110 via a wired or wireless connection, and receive imaging information from the camera 110. Similarly, the control system 130 may be communicably coupled to the propulsion system 130 to provide control signals to the propulsion system 130. In the illustrated example, the control system 130 is disposed on-board the vehicle 100. It may be noted that in other examples, all or a portion of the control system 130 may be disposed off-board of the vehicle. In the illustrated example, the control system 130 includes a processing unit 132 that represents one or more processors configured (e.g., programmed) to perform various tasks or activities discussed herein.

For example, the depicted example processing unit 132 is configured to receive imaging information from the vehicle 100. The processing unit 132 is also configured to determine an orientation of the vehicle 100 using the imaging information from the camera 110. Further, the processing unit 132 is configured to provide control signals to the propulsion system 130 to control the vehicle 100 based on the determined orientation. It may be noted that, for ease and clarity of illustration, in the depicted example, the processing unit 132 is shown as a single unit; however, in various embodiments the processing unit 132 may be distributed among or include more than one physical unit, and may be understood as representing one or more processors. The processing unit 132 represents hardware circuitry that includes and/or is connected with one or more processors (e.g., one or more microprocessors, integrated circuits, microcontrollers, field programmable gate arrays, etc.) that perform operations described herein. The processing unit 132 in various embodiments stores acquired information (e.g., information from the camera 110; information describing characteristics of the route 102, and/or information corresponding to expected content of images from the camera 110) in a tangible and non-transitory computer-readable storage medium (e.g., memory 134). In various example, the memory 134 (and/or an external memory accessed by the processing unit 132 via communication unit 136) may store a database with expected and/or archived image content associated with orientations at various locations at which the vehicle 100 may be disposed, such as expected buildings or other landmarks, expected positions of shadows at various times, or the like. The processing unit 132 performs calculations (e.g., identifying potential images for comparison and performing image processing to make comparisons of images to determine orientations) that cannot be performed practicably by a human mind. Additionally or alternatively, instructions for causing the processing unit 132 to perform one or more tasks discussed herein may be stored in a tangible and non-transitory computer-readable storage medium (e.g., memory 134).

It may be noted that the location of the vehicle 100 may be utilized in determining orientation. Location information in various embodiments includes geographic location and/or route identification (e.g., location on a particular set of rails among a group of adjacent rails.) In some embodiments, the location may be manually entered or provided to the processing unit 132. Alternatively or additionally, in some embodiments, the vehicle 100 may include a location detector 150 that provides location information to the processing unit 132. The depicted example location detector 150 is configured to obtain vehicle location information. The location detector 150, for example, in various embodiments includes one or more sensors located on-board the vehicle 100 and configured to utilize signals from a satellite such as a global positioning system (GPS) or other satellite positioning system. In some embodiments, the location detector 150 includes a GPS receiver disposed on-board the vehicle 100.

As mentioned above, the depicted processing unit 132 is configured to receive image information from the camera 110. In the illustrated example, the image information includes an image 140 that is output from the camera 110. For example, in some examples, the image 140 is a static image of surroundings of the vehicle 100 (e.g., a static image of a portion of an environment surrounding the vehicle 100 in the direction of orientation of the camera 110).

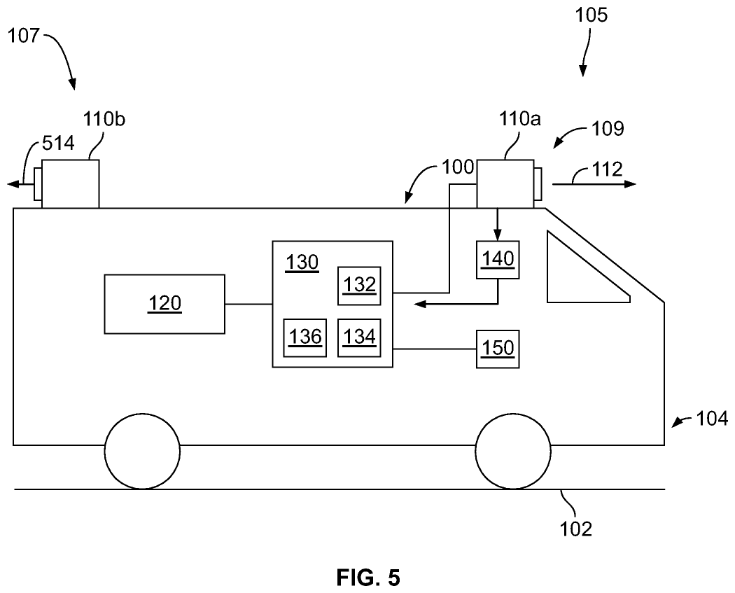

The processing unit 132 is further configured to determine an orientation of the vehicle 100 using the image information (e.g., image 140) output from the camera 110. In the example of FIG. 1, a single camera 110 in a fixed predetermined orientation (e.g., toward a front orientation of the vehicle in direction 112) is used. In other embodiments, one or more cameras may be utilized at different orientations, with the processing unit 132 configured to determine an orientation of a camera associated with a particular image, and to determine the orientation of that camera with respect to the vehicle, and then to determine the orientation of the vehicle using the camera orientation and the image information. For example, FIG. 5 provides an illustration of an example vehicle 100 having a forward facing camera 510a and a rearward facing camera 510b. the forward facing camera 110a is oriented toward the forward direction 112, and the rearward facing camera 510b is oriented in a rearward direction 514 that is opposite the forward direction 112. If an image from the forward facing camera 510a is used to determine a particular orientation, then the vehicle 100 is determined to be facing that particular orientation. However, if an image from the rearward facing camera 510b is used to determine a particular orientation, then the vehicle 100 is determined to be facing the opposite of that particular orientation. In some embodiments, the processing unit 132 may select between the forward camera and the rearward camera to obtain the image information (e.g., based on available light and/or quality or number of available aspects of images for use in determining orientation).

In some examples, in addition to the use of visual information describing or depicting surroundings of the vehicle 110, timing information is also utilized. For example, in some examples, the processing unit 132 determines timing information that indicates a time at which the image information was obtained by or from the camera 110, and to determine the orientation of the vehicle using the timing information. In an example, the timing information includes the time at which the image information was obtained, as well as the date on which the image information was obtained.

FIG. 2 provides an example of an image 140 that includes a time stamp 142. In various examples, the timing information may be determined from (or represented by) the time stamp 142. In the illustrated example, the timing information corresponds to or is included in the visual appearance of the image (e.g., as a displayed time stamp); however, it may be noted that in other embodiments the timing information may not be visually apparent in the image. For example, the timing information may be determined from information sent separately from an image that indicates or corresponds to a time at which the corresponding image was obtained. Using the time and date at which the image is obtained, the processing unit 132 in various examples determines an expected position of the sun and/or expected light intensity provided by the sun for a given location at which the vehicle 100 is determined to be located.

In some embodiments, the processing unit 132 is configured to determine shadow information (e.g., direction and/or length of one or more shadows associated with one or more corresponding objects in the image) using the image information, and to determine the orientation using the shadow information. In the example of FIG. 2, the image 140 includes an object 200 that casts a shadow 202. The shadow 202 may be identified in the image 140, for example, based on a proximity and position relative to the object 200 identified in the image 140 (e.g., using a priori knowledge of image contents and/or image recognition software). The shadow 202 has a length 204 and a direction 206 (e.g., relative to the object 200 from which it is cast) in the illustrated example. The length 204 and direction 206 of the shadow 202 may be used in determining an orientation of the camera 110 (and accordingly the orientation of the vehicle 100 with the orientation of the camera 110 relative to the vehicle 100 known). In various examples, by knowing the starting location of the vehicle 100, as well as the time and date at which the image was obtained, the direction and/or size of a shadow relative to an object casting the shadow may be compared with expected shadows from one or more potential orientations to determine the orientation of the vehicle 100. For example, a known date may be used to account for differences in shadows based on seasonal variations, and the time of day may be used to account for shadow placement based on a known sunrise to sunset timing pattern for that date.

For example, if for a given location of the vehicle 100 an image is obtained in the morning, and the vehicle 100 is on a rail or other route that runs generally north and south, the shadow 202 would be expected to be cast to the left in the image if the camera 110 were oriented northward and to the right if the camera 110 were oriented southward. Accordingly, if the shadow 202 is cast to the left, the vehicle 100 may be determined to be oriented northward (provided the camera 110 and vehicle 100 were oriented in the same direction). As another example, if for a given location of the vehicle 100 an image is obtained in the morning, and the vehicle 100 is on a rail or other route that runs generally east and west, the shadow 202 would be expected to not exist or be relatively short if the camera 110 were oriented generally eastward, and to be relatively longer if the camera 110 were oriented relatively westward. For orientations that are intermediate between compass points, a combination of direction and relative length of shadow could be used based on the position of the sun for that particular date and time at a given vehicle location

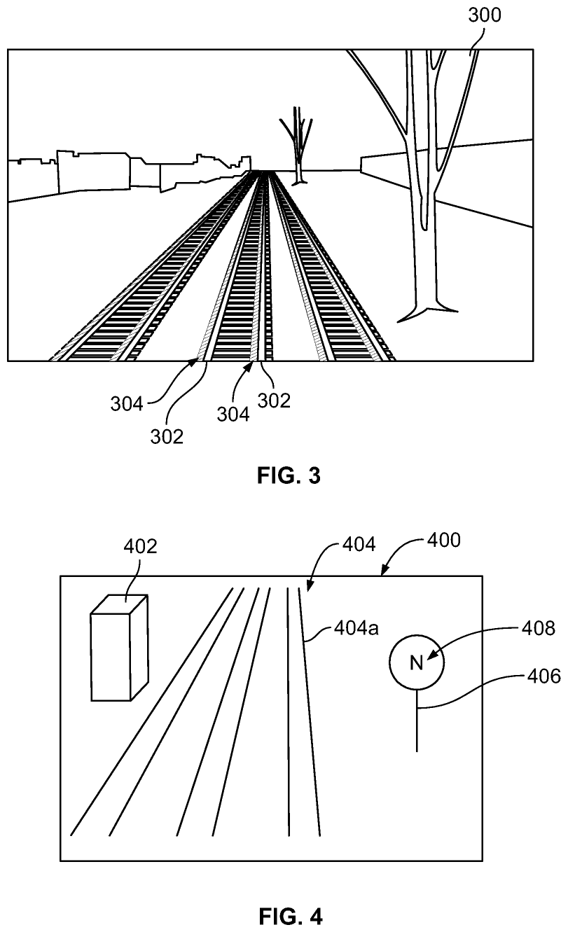

In some examples, shadows from relatively large objects such as trees or structures may be used. Additionally or alternatively, shadows from a portion of the route may be used. For example, shadows from rails on which a rail vehicle travels may be utilized. FIG. 3 illustrates an example image 300 in which shadows from rails may be used. In FIG. 3, shadows 304 are cast to the left of rails 302. Accordingly, using image recognition software, the processing unit 132 in the illustrated example determined that shadows 304 are cast to the left. The processing unit 132 may then use timing information (e.g., date and time at which image is obtained) and location information (e.g., geographical position of the vehicle along the route) to determine an expected position of the sun. For example, for the illustrated location, the processing unit 132 may determine that the date is November 17 and the time is 8:00 am Central Standard Time, and that for the location of the vehicle, the vehicle is oriented generally north if the shadows appear on the left (with the camera and vehicle oriented in the same direction in the illustrated example). Accordingly, with the shadows 304 toward the left, the processing unit 132 determines that the vehicle is oriented toward the north. If the vehicle were oriented in the reverse direction, the shadows 304 would be cast toward the right, so that if the shadows were seen toward the right, the processing unit 132 would determine the vehicle were oriented toward the south.

It may be noted that depending on the potential orientations of the route and/or time of year, additional precision may be desired. For example, a curved track may result in more potential orientations. As another example, use of a vehicle not constrained to only forward and reverse orientations would result in more potential orientations. As one more example, the orientation of the sun with respect to track orientation may result in more challenging orientation determinations at different times of year (e.g., casting a shorter or more difficult to detect shadow at a given time or times of year). If more precision is desired, in some examples, the processing unit 132 may measure the shadow and the object causing the shadow to determine a more precise heading. For example, the height of the object relative to a length of the shadow may be used. In some examples, a known size of an object in the image (e.g., an aspect of the route such as rails) may be used for scaling. For example, a standard or otherwise known spacing of rails may be used to determine a scale for accurate measurement.

Alternatively or additionally to shadow information, in some examples the processing unit 132 determines light intensity information using the imaging information, and determines the orientation using the light intensity information. For example, if shadows are not present in an image, light intensity information may be used. In one example, a direction of orientation may be determined or estimated based on the exposure level of the image compared to the time and date information. The intensity of the light may be used to estate where the sun is positioned in the sky. With the position of the sun and timestamp information known, a direction may be estimated. As another example, for vehicles having two cameras oriented in different directions, the intensity of the light may be compared. For example, an eastward orientation in the morning may be expected to have brighter light than a westward orientation. Accordingly, based on a comparison of light intensity, the relative orientations of the two cameras may be determined (e.g., the camera providing an image with higher light intensity in the morning is identified as facing eastward and the camera resulting in lower intensity is identified as facing westward), and the orientation of the vehicle determined based on known camera orientations relative to the vehicle orientation.

It may be noted that various examples may be used with or without timing information. In some examples, the processing unit 132 is configured to compare the image information from the camera 110 with stored information to determine an orientation of the vehicle 100. For example, images may be obtained previously for each possible orientation at a given location and stored in memory 134 or an off-board memory that may be accessed by the processing unit 132. Then, aspects of a currently obtained image are compared with archived examples for the same location, with each archived example associated with a particular orientation. The orientation corresponding to the archived example that most closely matches the current image may then be used to determine the orientation.

For example, in some embodiments, the processing unit 132 is configured to determine landmark information corresponding to the position of one or more landmarks in the image information, and to determine the orientation of the vehicle using the landmark information. The landmark information generally corresponds to landmarks or expected features of an image identified by the processing unit 132 (e.g., using image recognition software). The landmark information in various example corresponds to structural features (e.g., buildings, bridges), operational landmarks (e.g., rails), and/or purpose-built landmarks (e.g., signposts). An example image provided by FIG. 4 provides examples of landmarks in an image 400 that may be utilized to help determined orientation. For example, the image 400 includes a building 402. By comparing the position and/or size of the building 402 with archived images from the same location, the orientation may be determined by identifying an orientation associated with an archived image having a similarly positions and/or sized building. As another example, the image 400 includes rails 404. If the position of the vehicle, for example, is known to be on a given rail, the position of the other rails in the image may be used to determine orientation. For example, with the vehicle on a far set of rails 404a as indicated in the image 400, if the remaining rails are to the left in the image a first orientation may be determined, but if the remaining rails are to the right, a second orientation opposite to the first may be determined. As one more example, the image 400 includes a signpost 406 that may be mounted in the location. The shape of the signpost 406 (e.g., a round signpost oriented with a first orientation and a square signpost oriented in a second direction) may be used in various examples. As another example, the signpost 406 in the illustrated example includes a text reference 408 (“N” representing north in the illustrated example). By identifying the content of the text reference 408 using image recognition software, the processing unit 132 may determine the direction of orientation.

As another example, the processing unit 132 may be configured to determine environmental information, and then determine the orientation using the environmental information. For example, the processing unit 132 may utilize image recognition software to identify trees in an image and the position of moss on trees to estimate a direction of orientation.

With continued reference to FIG. 1, the control system 130 (e.g., processing unit 132) is also configured to provide control signals to the propulsion system to control the vehicle based on the determined orientation. In this respect, the control system may be referred to and/or include a controller that may be referred to as a vehicle controller. The vehicle controller can represent an engine control unit, an onboard navigation system, or the like, that can control a propulsion system (e.g., one or more engines, motors, etc.) and/or a braking system (e.g., one or more friction brakes, air brakes, regenerative brakes, etc.) to control movement of the vehicle. It may be noted that the control signals may be based on internally determined actions (e.g., from a trip plan and/or operator input) and/or external determinations (e.g., information sent from a PTC system to the control system 130 via communication unit 136).

In some examples, the control system 130 may control the vehicle 100 by over-riding an attempted command by an operator. For example, the control system 130 may provide the determined orientation to a positive train control (PTC) system, with the PTC system controlling the vehicle 100 as the vehicle 100 traverses a territory governed by the PTC system. It may be noted that in some examples, the orientation may be provided to a system that is off-board of the vehicle (or has aspects located off-board of the vehicle) and cooperates with the control system 130.

More generally, a determined orientation (e.g., a vehicle orientation that is determined as set forth in one or more embodiments herein) may be used as part of the basis for controlling the vehicle in a positive vehicle control system. A positive vehicle control system is a control system in which a vehicle is allowed to move, and/or is allowed to move outside a designated restricted manner, only responsive to receipt or continued receipt of one or more signals (e.g., received from off-board the vehicle) having designated characteristics/criteria and/or that are received according to designated time criteria. Further, while various examples may be utilized in connection with a positive control system (e.g., a system in which a vehicle is not allowed to enter a route segment unless a signal is received that gives permission), it may be noted that other embodiments may be utilized in connection with negative control systems (e.g., a system in which a vehicle is allowed to enter any route segment unless a signal is received denying permission) and/or other types of control systems.

In one embodiment, a system includes one or more processors. The one or more processors are configured to receive image information from a vision sensor disposed on a vehicle, determine timing information indicating a time at which the image information was obtained, determine an orientation of the vehicle using the timing information, and control the vehicle based on the orientation that is determined.

Optionally, the one or more processors are configured to control the vehicle by over-riding an attempted command by an operator.

Optionally, the image information includes a static image of surroundings of the vehicle.

Optionally, the one or more processors are configured to determine shadow information using the image information, and to determine the orientation of the vehicle using the shadow information.

Optionally, the one or more processors are configured to determine light intensity information using the imaging information, and to determine the orientation using the light intensity information.

Optionally, the one or more processors are configured to determine environmental information, and to determine the orientation using the environmental information.

Optionally, the one or more processors are configured to determine landmark information corresponding to the position of one or more landmarks in the image information, and to determine the orientation using the landmark information.

Optionally, the one or more processors are configured to compare the image information from the vision sensor with stored information to determine an orientation of the vehicle.

Optionally, the one or more processors are configured to determine a sensor orientation of the vision sensor with respect to the orientation of the vehicle, and to determine the orientation of the vehicle based on the sensor orientation and the image information.

In one embodiment, a vehicle includes at least one camera, a propulsion system, and a control system. The at least one camera is disposed on the vehicle. The propulsion system is disposed on the vehicle, and is configured to provide tractive efforts to the vehicle. The control system operably coupled to the at least one camera and the propulsion system. The control system includes one or more processors configured to receive image information from the at least one camera disposed on the vehicle, the image information including an image output from the at least one camera disposed on the vehicle; determine an orientation of the vehicle using the image output from the at least one camera disposed on the vehicle; provide control signals to the propulsion system to control the vehicle based on the determined orientation.

Optionally, the control system is configured to control the vehicle by over-riding an attempted command by an operator.

Optionally, the one or more processors are configured to determine timing information indicating a time at which the image information was obtained, and to determine the orientation of the vehicle using the timing information. For example, in some embodiments, the one or more processors are configured to determine shadow information using the image information, and to determine the orientation using the shadow information. Alternatively or additionally, in various embodiments, the one or more processors are configured to determine light intensity information using the imaging information, and to determine the orientation using the light intensity information.

Optionally, the one or more processors are configured to determine landmark information corresponding to the position of one or more landmarks in the image information, and to determine the orientation using the landmark information.

Optionally, the one or more processors are configured to determine a camera orientation of the at least one camera with respect to the orientation of the vehicle, and to determine the orientation of the vehicle based on the camera orientation and the image information.

Optionally, the at least one camera includes a forward camera and a rearward camera oriented in an opposite direction from the forward camera, with the one or more processors configured to select between the forward camera and the rearward camera to obtain the image information.

In one embodiment, a vehicle includes at least one camera disposed on the vehicle, a propulsion system disposed on the vehicle, and a control system. The propulsion system is disposed on the vehicle, and is configured to provide tractive efforts to the vehicle. The control system is operably coupled to the at least one camera and the propulsion system. The control system includes one or more processors configured to receive image information from the at least one camera disposed on the vehicle, determine timing information indicating a time at which the image information was obtained, determine an orientation of the vehicle using the timing information, and provide control signals to the propulsion system to control the vehicle based on the determined orientation.

Optionally, the control system is configured to control the vehicle by over-riding an attempted command by an operator.

Optionally, the image information includes an image output from the at least one camera disposed on the vehicle.

Optionally, the one or more processors are configured to determine shadow information using the image information, and to determine the orientation using the shadow information.

Optionally, the one or more processors are configured to determine light intensity information using the imaging information, and to determine the orientation using the light intensity information.

Optionally, the one or more processors are configured to determine a camera orientation of the at least one optical camera with respect to the orientation of the vehicle, and to determine the orientation of the vehicle based on the camera orientation and the image information.

Optionally, the at least one camera includes a forward camera and a rearward camera oriented in an opposite direction from the forward camera, and the one or more processors are configured to select between the forward camera and the rearward camera to obtain the image information.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors configured to:
receive image information from a vision sensor disposed on a vehicle;
determine timing information indicating a time at which the image information was obtained;
determine an orientation of the vehicle using the timing information; and
control the vehicle based on the orientation that is determined.

2. The system of claim 1, wherein the one or more processors are configured to control the vehicle by over-riding an attempted command by an operator.

3. The system of claim 1, wherein the image information includes a static image of surroundings of the vehicle.

4. The system of claim 1, wherein the one or more processors are configured to determine shadow information using the image information, and to determine the orientation using the shadow information.

5. The system of claim 1, wherein the one or more processors are configured to determine light intensity information using the image information, and to determine the orientation using the light intensity information.

6. The system of claim 1, wherein the one or more processors are configured to determine environmental information, and to determine the orientation using the environmental information.

7. The system of claim 1, wherein the one or more processors are configured to determine landmark information corresponding to a position of one or more landmarks in the image information, and to determine the orientation using the landmark information.

8. The system of claim 1, wherein the one or more processors are configured to compare the image information from the vision sensor with stored information to determine the orientation of the vehicle.

9. The system of claim 1, wherein the one or more processors are configured to determine a sensor orientation of the vision sensor with respect to the orientation of the vehicle, and to determine the orientation of the vehicle based on the sensor orientation and the image information.

10. A vehicle including:
at least one camera disposed on the vehicle;
a propulsion system disposed on the vehicle and configured to move the vehicle; and
a control system operably coupled to the at least one camera and the propulsion system, the control system including one or more processors configured to:
receive image information from the at least one camera disposed on the vehicle, the image information including an image output from the at least one camera disposed on the vehicle;
determine an orientation of the vehicle using the image output from the at least one camera disposed on the vehicle; and
provide control signals to the propulsion system to control the vehicle based on the orientation that is determined.

11. The vehicle of claim 10, wherein the control system is configured to control the vehicle by over-riding an attempted command by an operator.

12. The vehicle of claim 10, wherein the one or more processors are configured to determine timing information indicating a time at which the image information was obtained, and to determine the orientation of the vehicle using the timing information.

13. The vehicle of claim 12, wherein the one or more processors are configured to determine shadow information using the image information, and to determine the orientation using the shadow information.

14. The vehicle of claim 12, wherein the one or more processors are configured to determine light intensity information using the image information, and to determine the orientation using the light intensity information.

15. The vehicle of claim 10, wherein the one or more processors are configured to determine landmark information corresponding to a position of one or more landmarks in the image information, and to determine the orientation using the landmark information.

16. The vehicle of claim 10, wherein the one or more processors are configured to determine a camera orientation of the at least one camera with respect to the orientation of the vehicle, and to determine the orientation of the vehicle based on the camera orientation and the image information.

17. The vehicle of claim 10, wherein the at least one camera includes a forward camera and a rearward camera oriented in an opposite direction from the forward camera, and wherein the one or more processors are configured to select between the forward camera and the rearward camera to obtain the image information.

18. A vehicle including:
at least one camera disposed on the vehicle;
a propulsion system disposed on the vehicle and configured to move the vehicle; and
a control system operably coupled to the at least one camera and the propulsion system, the control system including one or more processors configured to:
receive image information from the at least one camera disposed on the vehicle;
determine timing information indicating a time at which the image information was obtained;
determine an orientation of the vehicle using the timing information; and
provide control signals to the propulsion system to control the vehicle based on the determined orientation.

19. The vehicle of claim 18, wherein the one or more processors are configured to determine shadow information using the image information, and to determine the orientation using the shadow information.

20. The vehicle of claim 18, wherein the one or more processors are configured to determine light intensity information using the image information, and to determine the orientation using the light intensity information.
